(19) United States
(12) Patent Application Publication
(10) Pub. No.: US 2014/0352443 A1
(43) Pub. Date: Dec. 4, 2014

(54) PIPE WALL THICKNESS MEASUREMENT

(71) Applicant: HALLIBURTON ENERGY SERVICES, INC., Houston, TX (US)

(72) Inventors: Laurence J. ABNEY, Sandnes (NO); Paul NICHOLLS, Southampton (GB)

(21) Appl. No.: 13/908,824

(22) Filed: Jun. 3, 2013

(51) Int. Cl. G01B 17/02

(52) U.S. Cl. CPC G01B 17/02
USPC 73/655

(57) ABSTRACT

A method of measuring a wall thickness of a pipe can include optically detecting vibration of the pipe, and computing the wall thickness of the pipe, the computing being based at least partially on the optically detected vibration. Another method of measuring a wall thickness of a pipe can include optically detecting temperature of the pipe, and computing the wall thickness of the pipe, the computing being based at least partially on the optically detected temperature. Another method of measuring a wall thickness of a pipe can include optically detecting vibration and temperature of the pipe, and computing the wall thickness of the pipe, the computing being based at least partially on the optically detected vibration and temperature.

### BACKGROUND

This disclosure relates generally to pipeline monitoring and, in an example described below, more particularly provides a technique for measuring pipe wall thickness.

Much time and expense is consumed each year testing pipelines to verify their structural integrity. For example, it is common practice to perform an inspection every four years (although regulations vary in different jurisdictions), in which a measurement device (e.g., a caliper, etc.) or a “smart pig” is displaced through a pipeline to measure wall thickness.

Therefore, it will be readily appreciated that improvements are continually needed in the art of pipeline monitoring. Such improvements could be effective, for example, to reduce the time and expense consumed by performing conventional wall thickness measurements.

### BRIEF DESCRIPTION OF THE DRAWINGS

FIG. 1 is a representative partially cross-sectional view of a pipeline monitoring system and associated method which can embody principles of this disclosure.

FIG. 2 is a representative cross-sectional view of a pipeline and optical cables in the pipeline monitoring system, taken along line 2-2 of FIG. 1.

FIG. 3 is a schematic flowchart for the method.

FIG. 4 is a schematic flowchart for another example of the method.

### DETAILED DESCRIPTION

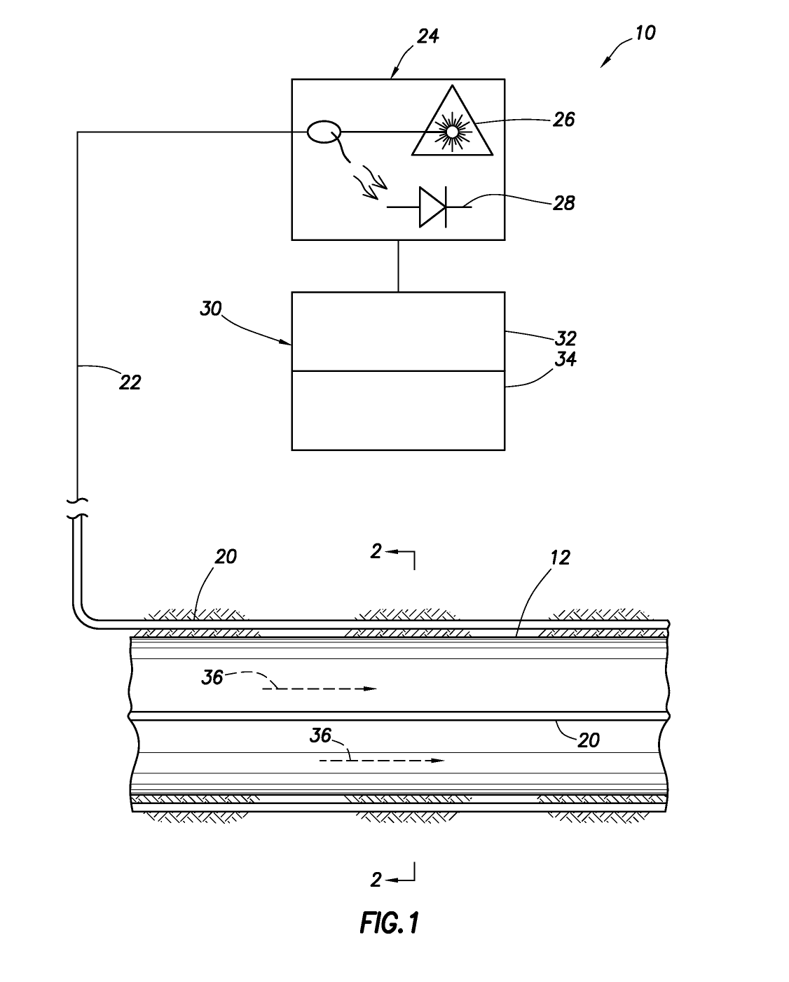

Representatively illustrated in FIG. 1 is a pipe wall thickness measurement system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a wall thickness of a pipe 12 can be determined by use of one or more optical cables or lines 20 positioned adjacent the pipe in the earth. As depicted in FIG. 1, the optical lines 20 are positioned external to the pipe 12, the optical lines extend straight longitudinally along the pipe, and each line is circumferentially spaced apart from adjacent lines by 90 degrees.

However, the optical lines 20 could be otherwise positioned, if desired. For example, an optical line 20 could extend helically about the pipe 12, the lines could be non-uniformly spaced apart, more or less lines could be used, etc. Thus, the scope of this disclosure is not limited to any particular numbers or positions of optical lines.

For clarity of discussion, only one of the optical lines 20 will be referred to in the description below, it being understood that any number of optical lines may be used. The optical line 20 may comprise a cable, a tubing, armor, protective sheathing, etc. The scope of this disclosure is not limited to use of any particular type of optical line.

The optical line 20 includes an optical waveguide 22. The optical waveguide 22 is connected to an optical interrogator 24 (for example, at a surface location). In this example, the interrogator 24 includes at least an optical source 26 (such as, an infrared laser, a light emitting diode, etc.) and an optical sensor 28 (such as, a photo-detector, photodiode, etc.). In some examples, the interrogator 24 could include an optical time domain reflectometer (OTDR).

The interrogator 24 may detect Brillouin backscatter gain, coherent Rayleigh backscatter, and/or Raman backscatter which results from light being transmitted through the optical waveguide 22. In other examples, separate interrogators 24 may be used to detect different types of optical scattering. However, the scope of this disclosure is not limited to use of any particular type or number of interrogators 24.

Operation of the interrogator 24 is controlled by a computer 30 including, for example, at least a processor 32 and memory 34. Instructions for operating the interrogator 24, and information output by the interrogator, may be stored in the memory 34. The computer 30 also preferably includes provisions for user input and output (such as, a keyboard, display, printer, touch-sensitive input, etc.). However, the scope of this disclosure is not limited to use of any particular type of computer.

In this example, the optical waveguide 22 is used to detect acoustic or vibrational energy as distributed along the waveguide, as well as temperature as distributed along the waveguide. In some examples, different optical waveguides 22 may be used to detect respective different parameters.

The optical waveguide 22 may comprise an optical fiber, optical ribbon or any other type of optical waveguide. The optical waveguide 22 may comprise a single mode or multi-mode waveguide, or any combination thereof.

One or more distributed optical sensing techniques may be used in the system 10. These techniques can include detection of Brillouin scattering and/or coherent Rayleigh scattering resulting from transmission of light through the optical waveguide 22. Raman scattering may be detected and, if used in conjunction with detection of Brillouin scattering, may be used for thermally calibrating the Brillouin scatter detection data in situations, for example, where accurate strain measurements are desired.

Optical sensing techniques can be used to detect static strain, dynamic strain, acoustic vibration and/or temperature. These optical sensing techniques may be combined with any other optical sensing techniques, such as hydrogen sensing, stress sensing, etc.

Stimulated Brillouin scatter detection can be used to monitor acoustic energy along the optical waveguide 22. Coherent Rayleigh scatter can be detected as an indication of vibration of the optical waveguide 22.

The optical waveguide 22 could include one or more waveguides for Brillouin scatter detection, depending on the Brillouin method used (e.g., linear spontaneous or non-linear stimulated). The Brillouin scattering detection technique measures the natural acoustic velocity via corresponding scattered photon frequency shift in the waveguide 22 at a given location along the waveguide.

Coherent Rayleigh scatter detection can be used to monitor dynamic strain (e.g., acoustic pressure and vibration). Coherent Rayleigh scatter detection techniques can detect acoustic signals which result in vibration of the optical waveguide 22.

Raman scatter detection techniques are preferably used for monitoring distributed temperature. Such techniques are known to those skilled in the art as distributed temperature sensing (DTS).

Raman scatter is relatively insensitive to distributed strain, although localized bending in a waveguide can be detected. Temperature measurements obtained using Raman scatter detection techniques can, for example, be used for temperature calibration of Brillouin scatter measurements.

Raman light scattering is caused by thermally influenced molecular vibrations. Consequently, the scattered light carries the local temperature information at the point where the scattering occurred.

The amplitude of an Anti-Stokes component is strongly temperature dependent, whereas the amplitude of a Stokes component of the backscattered light is not. Raman scatter sensing requires some optical-domain filtering to isolate the relevant optical frequency (or optical wavelength) components, and is based on the recording and computation of the ratio between Anti-Stokes and Stokes amplitude, which contains the temperature information.

Since the magnitude of the spontaneous Raman scattered light is quite low (e.g., 10 dB less than Brillouin scattering), high numerical aperture (high NA) multi-mode optical waveguides are typically used, in order to maximize the guided intensity of the backscattered light. However, the relatively high attenuation characteristics of highly doped, high NA, graded index multi-mode waveguides, in particular, limit the range of Raman-based systems to approximately 10 km.

Brillouin light scattering occurs as a result of interaction between the propagating optical signal and thermally excited acoustic waves (e.g., within the GHz range) present in silica optical material. This gives rise to frequency shifted components in the optical domain, and can be seen as the diffraction of light on a dynamic in situ “virtual” optical grating generated by an acoustic wave within the optical media. Note that an acoustic wave is actually a pressure wave which introduces a modulation of the index of refraction via an elasto-optic effect.

The diffracted light experiences a Doppler shift, since the grating propagates at the acoustic velocity in the optical media. The acoustic velocity is directly related to the silica media density, which is temperature and strain dependent. As a result, the so-called Brillouin frequency shift carries with it information about the local temperature and strain of the optical media.

Note that Raman and Brillouin scattering effects are associated with different dynamic non-homogeneities in silica optical media and, therefore, have completely different spectral characteristics.

Coherent Rayleigh light scattering is also caused by fluctuations or non-homogeneities in silica optical media density, but this form of scattering is purely “elastic.” In contrast, both Raman and Brillouin scattering effects are “inelastic,” in that “new” light or photons are generated from the propagation of the laser probe light through the media.

In the case of coherent Rayleigh light scattering, temperature or strain changes are identical to an optical source (e.g., very coherent laser) wavelength change. Unlike conventional Rayleigh scatter detection techniques (using common optical time domain reflectometers), because of the extremely narrow spectral width of the laser source (with associated long coherence length and time), coherent Rayleigh (or phase Rayleigh) scatter signals experience optical phase sensitivity resulting from coherent addition of amplitudes of the light scattered from different parts of the optical media which arrive simultaneously at a photo-detector.

In the FIG. 1 example, flow of a fluid 36 through the pipe 12 will cause a characteristic vibration of the pipe and a characteristic temperature change of the pipe. The vibration and temperature detected using the optical lines 20 will depend on various factors (including, for example, a temperature and flow rate of the fluid 36, the type of fluid, etc.).

It will be appreciated by those skilled in the art that one factor that will affect the detected vibration and temperature of the pipe 12 is a wall thickness of the pipe. For example, a thicker wall thickness would be expected to have a higher natural vibration frequency, and less overall thermal conductivity, as compared to a thinner wall thickness.

Thus, for a given diameter of the pipe 12, a variation in wall thickness is expected to produce a corresponding vibration “signature” and a corresponding temperature “signature” for flow of a fluid 36 having certain properties through the pipe. Such vibration and temperature signatures can be experimentally determined and compiled into lookup tables for pipes of various diameters, so that an actual measured vibration and/or temperature signature could be compared to the lookup tables, in order to determine a wall thickness of the pipe 12.

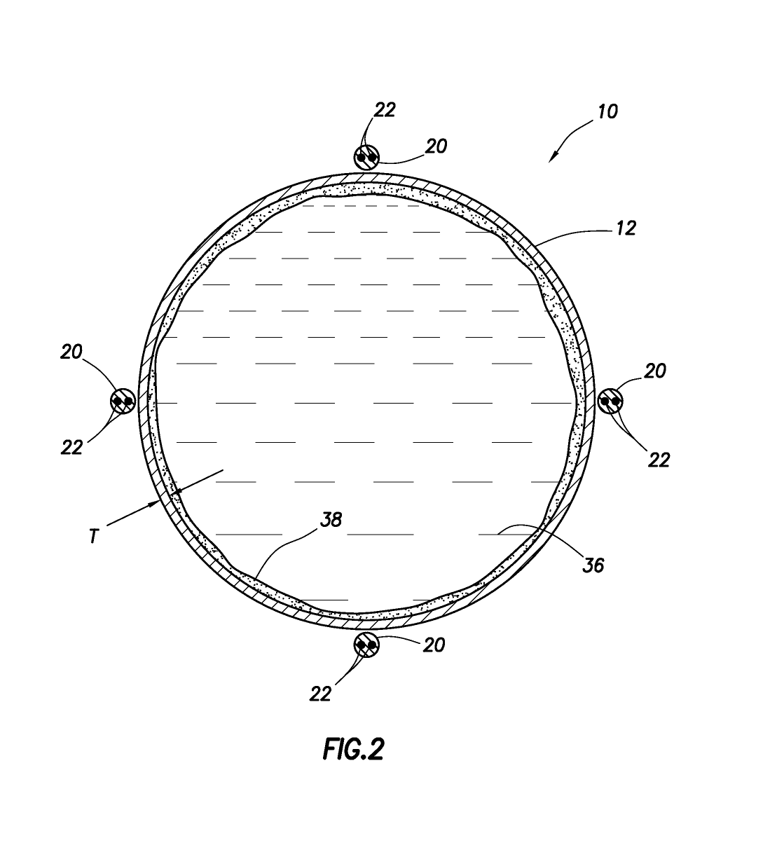

Referring additionally now to FIG. 2, a cross-sectional view of the pipe 12 and optical lines 20 is representatively illustrated. In this example, each of the lines 20 includes two optical waveguides 22 therein, but other numbers and arrangements of waveguides may be used in keeping with the scope of this disclosure. In one example, the optical waveguides 22 may be enclosed in a metal tube.

Also visible in FIG. 2 is a buildup of a substance 38 (such as, hydrates, etc.) on an interior of the pipe 12. Note that flow of the fluid 36 across the substance 38 can influence the vibration signature and the temperature signature detected by the optical waveguides 22.

Indeed, flow of the fluid 36 across the substance 38 can be a major source of the vibrations detected by the optical waveguides 22. Thus, the detected vibration signature can also be indicative of the buildup of the substance 38 on the interior of the pipe 12. Since the presence of the substance 38 will also affect the thermal conductivity of the pipe 12, the detected thermal signature can also be indicative of the buildup of the substance.

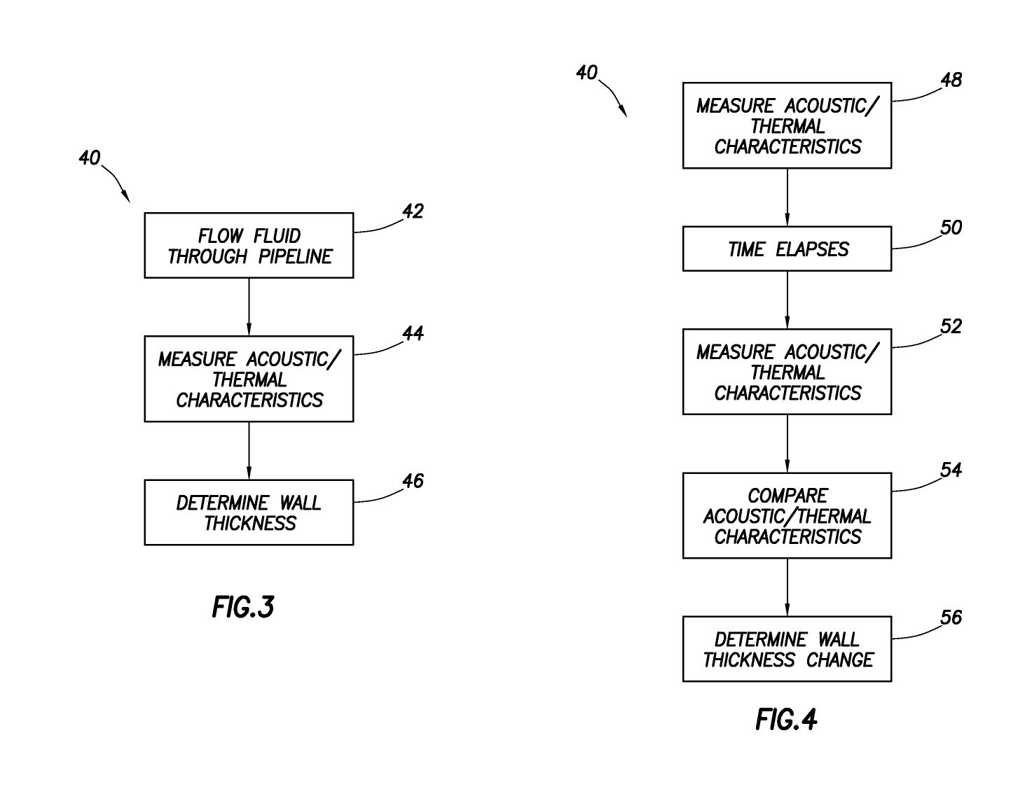

Referring additionally now to FIG. 3, a method 40 of determining a wall thickness T of the pipe 12 is representatively illustrated in flowchart form. Note that the wall thickness T may or may not include a thickness of a substance 38 on the interior of the pipe 12.

In a step 42 of the method 40, the fluid 36 is flowed through the pipe 12. Preferably, the nominal diameter of the pipe 12 is known and, if temperature distributed along the pipe is to be measured, the temperatures of the fluid 36 and of the pipe are known prior to the fluid 36 being flowed through the pipe.

In step 44, acoustic/vibration and/or thermal measurements are made along the pipe 12 as the fluid 36 is flowed through the pipe. As discussed above, the pipe 12 will have a characteristic vibration signature, which depends on its wall thickness T. The pipe 12 will also have a characteristic thermal signature (e.g., temperature variation along its length), which depends on its wall thickness T.

In step 46, the wall thickness T is determined, based on the measured vibration and/or thermal signature(s). For example, a lookup table could be consulted for a nominal diameter of the pipe 12, giving natural frequencies of different pipe wall thicknesses. Alternatively, or in addition, a lookup table could provide a characteristic thermal variation per unit length for different pipe wall thicknesses. In other examples, algorithms could be derived to model vibration and/or thermal characteristics for different pipe wall thicknesses. Thus, the scope of this disclosure is not limited to any particular technique for relating a detected vibration signature and/or a detected thermal signature to a wall thickness of a pipe.

Referring additionally now to FIG. 4, another example of the method 40 is representatively illustrated in flowchart form. In this example, vibration and/or thermal signatures are measured at different times, in order to detect how the pipe 12 wall thickness T changes over time.

For example, a starting wall thickness T of the pipe 12 may be known at some point (e.g., upon installation of the pipe, upon later inspection of the pipe, etc.). By comparing a vibration and/or thermal signature(s) of the pipe 12 when the wall thickness T is known to a later measured vibration and/or thermal signature(s), a change in the wall thickness can be readily determined.

In step 48, a vibration and/or thermal signature of the pipe 12 is measured with the fluid 36 flowing through the pipe. Preferably, at this point, the wall thickness T of the pipe 12 is known. This step 48 is similar to step 44 in the method 40 as depicted in FIG. 3, with the exception that the wall thickness T is known.

In step 50, time elapses. During this time, the wall thickness T may decrease (for example, due to erosion, corrosion, etc.), the wall thickness may increase (for example, due to hydrate accumulation, etc.), or the wall thickness could remain the same.

In step 52, a vibration and/or thermal signature of the pipe 12 is measured again, with preferably the same fluid 36 flowing through the pipe as in step 48. However, another fluid may be used, if desired.

In step 54, the vibration and/or thermal signatures measured in steps 48 and 52 are compared, for example, to determine how the signature(s) have changed over the elapsed time.

In step 56, a change in the wall thickness T is determined, based on the change in the vibration and/or thermal signature(s) in step 54. Thus, knowing the initial wall thickness T, and the change in wall thickness from step 56, the current wall thickness of the pipe 12 can be readily determined.

It may now be fully appreciated that the above disclosure provides significant advancements to the arts of inspecting pipes and measuring pipe wall thicknesses. The methods described above can be practiced without requiring any measurement tool or “pig” to be displaced through the pipe 12, and without requiring shutdown of a pipeline for an extended period of time.

A method of measuring a wall thickness T of a pipe 12 is provided to the art by the above disclosure. In one example, the method can comprise: optically detecting vibration of the pipe 12; and computing the wall thickness T of the pipe 12. The computing is based at least partially on the optically detected vibration.

The vibration of the pipe 12 may be produced by flow of a fluid 36 through the pipe 12. The vibration of the pipe 12 may be further produced by flow of the fluid 36 across a substance 38 (such as hydrates, etc.) which accumulates in the pipe 12.

The optically detecting step can be performed by detecting scattering of light in an optical waveguide 22. The scattering can comprise Brillouin scattering and/or coherent Rayleigh scattering.

The vibration of the pipe 12 can comprise acoustic vibration.

The computing step can include comparing the optically detected vibration to a lookup table corresponding to a diameter of the pipe 12. The computing step can be based, at least in part, on a nominal diameter of the pipe 12. The computing step can comprise comparing the optically detected vibration of the pipe 12 to a previously optically detected vibration of the pipe 12.

The method can include optically detecting a temperature of the pipe 12, and the computing step can be further based on the optically detected temperature of the pipe 12.

Also described above is a method of measuring a wall thickness T of a pipe 12, in which the method comprises: optically detecting temperature of the pipe 12; and computing the wall thickness T of the pipe 12, with the computing being based at least partially on the optically detected temperature.

The temperature of the pipe 12 may be produced at least partially by flow of a fluid 36 through the pipe 12 and/or by flow of the fluid 36 across a substance 38 which accumulates in the pipe 12.

The optically detecting step may be performed by detecting scattering of light in an optical waveguide 22. The scattering can comprise Raman scattering.

The computing step can include comparing the optically detected temperature to a lookup table corresponding to a diameter of the pipe 12. The computing step may be based, at least in part, on a nominal diameter of the pipe 12. The computing step can include comparing the optically detected temperature of the pipe 12 to a previously optically detected temperature of the pipe 12.

Another method of measuring a wall thickness T of a pipe 12 can comprise: optically detecting vibration and temperature of the pipe 12; and computing the wall thickness T of the pipe 12, the computing being based at least partially on the optically detected vibration and temperature.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of measuring a wall thickness of a pipe, the method comprising:
optically detecting vibration of the pipe; and
computing the wall thickness of the pipe, the computing being based at least partially on the optically detected vibration.

2. The method of claim 1, wherein the vibration of the pipe is produced by flow of a fluid through the pipe.

3. The method of claim 2, wherein the vibration of the pipe is further produced by flow of the fluid across a substance which accumulates in the pipe.

4. The method of claim 1, wherein the optically detecting is performed by detecting scattering of light in an optical waveguide.

5. The method of claim 4, wherein the scattering comprises Brillouin scattering.

6. The method of claim 4, wherein the scattering comprises coherent Rayleigh scattering.

7. The method of claim 1, wherein the vibration comprises acoustic vibration.

8. The method of claim 1, wherein the computing further comprises comparing the optically detected vibration to a lookup table corresponding to a diameter of the pipe.

9. The method of claim 1, wherein the computing is further based on a nominal diameter of the pipe.

10. The method of claim 1, wherein the computing further comprises comparing the optically detected vibration of the pipe to a previously optically detected vibration of the pipe.

11. The method of claim 1, further comprising optically detecting a temperature of the pipe, and wherein the computing is further based on the optically detected temperature of the pipe.

12. A method of measuring a wall thickness of a pipe, the method comprising:
optically detecting temperature of the pipe; and
computing the wall thickness of the pipe, the computing being based at least partially on the optically detected temperature.

13. The method of claim 12, wherein the temperature of the pipe is produced at least partially by flow of a fluid through the pipe.

14. The method of claim 13, wherein the temperature of the pipe is further produced by flow of the fluid across a substance which accumulates in the pipe.

15. The method of claim 12, wherein the optically detecting is performed by detecting scattering of light in an optical waveguide.

16. The method of claim 15, wherein the scattering comprises Raman scattering.

17. The method of claim 12, wherein the computing further comprises comparing the optically detected temperature to a lookup table corresponding to a diameter of the pipe.

18. The method of claim 12, wherein the computing is further based on a nominal diameter of the pipe.

19. The method of claim 12, wherein the computing further comprises comparing the optically detected temperature of the pipe to a previously optically detected temperature of the pipe.

20. The method of claim 12, further comprising optically detecting a vibration of the pipe, and wherein the computing is further based on the optically detected vibration of the pipe.

21. A method of measuring a wall thickness of a pipe, the method comprising:
optically detecting vibration and temperature of the pipe; and
computing the wall thickness of the pipe, the computing being based at least partially on the optically detected vibration and temperature.

22. The method of claim 21, wherein the vibration and temperature of the pipe is produced by flow of a fluid through the pipe.

23. The method of claim 22, wherein the vibration and temperature of the pipe is further produced by flow of the fluid across a substance which accumulates in the pipe.

24. The method of claim 21, wherein the optically detecting is performed by detecting scattering of light in an optical waveguide.

25. The method of claim 24, wherein the scattering comprises Brillouin scattering.

26. The method of claim 24, wherein the scattering comprises Raman scattering.

27. The method of claim 24, wherein the scattering comprises coherent Rayleigh scattering.

28. The method of claim 21, wherein the vibration comprises acoustic vibration.

29. The method of claim 21, wherein the computing further comprises comparing the optically detected vibration and temperature to a lookup table corresponding to a diameter of the pipe.

30. The method of claim 21, wherein the computing is further based on a nominal diameter of the pipe.

31. The method of claim 21, wherein the computing further comprises comparing the optically detected vibration and temperature of the pipe to a previously optically detected vibration and temperature of the pipe.
